(19) United States
(12) Patent Application Publication
(10) Pub. No.: US 2023/0266480 A1
(43) Pub. Date: Aug. 24, 2023

(54) Method for Determining an Integrity Datum regarding a GNSS-Based Localization of a Vehicle

(71) Applicant: Robert Bosch GmbH, Stuttgart (DE)

(72) Inventors: Mohammad Tourian, Stuttgart (DE); Jens Strobel, Freiberg Am Neckar (DE)

(21) Appl. No.: 18/170,310

(22) Filed: Feb. 16, 2023

(30) Foreign Application Priority Data
Feb. 21, 2022 (DE) 10 2022 201 756.0

(51) Int. Cl. G01S 19/39; G01S 19/48

(52) U.S. Cl. CPC G01S 19/396; G01S 19/48

(57) ABSTRACT

A method for determining an integrity datum regarding a GNSS-based localization of a vehicle includes (i) receiving GNSS satellite signals from at least one GNSS satellite and determining GNSS localization data using the received GNSS satellite signals, (ii) receiving 5G signals and determining 5G localization data using the received 5G signals, and (iii) determining a first integrity datum in consideration of at least received 5G signals or determined 5G localization data.

This application claims priority under 35 U.S.C. § 119 to patent application no. DE 10 2022 201 756.0, filed on Feb. 21, 2022 in Germany, the disclosure of which is incorporated herein by reference in its entirety.

The disclosure relates to a method for determining an integrity datum regarding a GNSS-based localization of a vehicle. Furthermore, a computer program, a machine-readable storage medium, a localization device, and a use are specified. The method can be used, for example, in connection with at least semi-assisted and/or automated driving.

### BACKGROUND

In recent years, satellite-based positioning has undergone rapid development. In the beginnings of satellite navigation, GNSS receivers had to rely on a single constellation of satellites in the orbit in order to determine their position, either the American GPS or the Russian GLONASS system. Today, with the European Galileo system and the Chinese Beidou system, there are more ready-to-use systems as well as a plurality of regional extension systems added to the two original systems. Today, GNSS receivers having multiple constellations that can receive signals from all of the GNSS constellations in the orbit are the norm. Thus, the receivers are able to track a larger number of satellites, even when large portions of the sky are obscured, such as in urban (or actual) street canyons, which increases the accuracy and reduces the time needed for positioning.

The quality of GNSS positioning has long been improved through commercial GNSS correction services. GNSS correction service providers typically monitor incoming GNSS signals via a network of base stations with precisely known positions and provide tailored correction information to end users for a fee.

The combination of multi-constellation and multi-band receivers with new GNSS correction methods in order to achieve accuracy in the centimeter range, all while significantly reducing operational costs, advantageously paves the way for new types of mass market applications for highly accurate positioning in the centimeter range.

However, GNSS localization continues to suffer various drawbacks. The receivers should ideally be within visibility of the circumferential satellites in order to be able to determine the position. In interior spaces and/or tunnels, the services are usually deteriorated or unavailable. A GNSS receiver typically takes several seconds after a cold start in order to uniquely determine its position for the first time.

With the help of inertial sensors, so-called dead reckoning solutions can advantageously extend the range of high-precision positioning beyond the reach of GNSS signals. Despite the improvements made by the inertial sensors, positional errors can also occur with GNSS/INS based localization sensors, particularly in urban street canyons where GNSS measurements can be compromised by multi-path signals.

Proceeding from the above, GNSS-based localization, and in particular its accuracy and/or integrity, is to be improved.

### SUMMARY

A method is proposed hereinafter for determining an integrity datum regarding a GNSS-based localization of a vehicle, comprising at least the following steps:

a) receiving GNSS satellite signals from at least one GNSS satellite and determining GNSS localization data using the received GNSS satellite signals,
b) receiving 5G signals and determining 5G localization data using the received 5G signals,
c) determining a first integrity datum in consideration of at least received 5G signals or determined 5G localization data.

For example, steps a), b), and c) can be performed at least once and/or repeatedly in the order indicated to carry out the method. Furthermore, steps a), b) and c), in particular steps a) and b), can be carried out at least partially in parallel or simultaneously. The method can advantageously contribute to the calculation of a GNSS protection level as reliable as possible using 5G signals.

For example, the integrity datum can be a measure of integrity and/or confidence of at least one localization result. For example, the integrity datum can be provided in the manner of a confidence interval in which the (true) position is located. Particularly preferably, the integrity datum is provided in the form of a so-called protection level.

In this context, GNSS is a global navigation satellite system such as GPS (Global Positioning System) or Galileo. GNSS-based localization can also employ other GNSS-independent sensors of the vehicle, such as environmental sensors and/or inertial sensors, in order to provide alternative information for the localization of the vehicle in addition or as needed (for example, in case of GNSS shadowing). For example, GNSS-based localization can comprise a combined GNSS-INS-based localization. In this context, for example, inertial sensor data can be included in the localization. For the localization, in particular, the instantaneous (own) position, (own) orientation, (own) speed, and/or (own) acceleration of the vehicle can be determined.

For example, the system can be a vehicle, such as an automobile. The vehicle is preferably configured for an at least semi-assisted or automated (or autonomous) driving operation. In corresponding vehicles, a plurality of environmental sensors can be used in addition to at least one GNSS receiver (for example: RADAR sensors, LIDAR sensors, camera sensors, ultrasonic sensors). For example, these environmental sensors can be used in order to detect and locate objects around the vehicle. Moreover, for example, environmental sensor data and/or GNSS data can be used in order to locate the vehicle on a (highly accurate) digital map. Trajectory planning and, if necessary, triggering of the vehicle actuators in order to carry out (automated or autonomous) driving operations can be carried out based on the detected objects or determined vehicle positions. In this way, the vehicle is advantageously able to navigate safely through the environment.

5G is the common name for the next generation of cellular technology that is already underway. Several mobile network operators have already publicly announced the construction of 5G networks, initially in urban centers. The forces behind 5G are diverse. New applications are placing higher demands for reliability, availability, coverage, and latency of cellular network performance. Mobile network operators wish to tap into new sources of revenue in a variety of industries with 5G.

The method can in particular be used (in a targeted manner) in urban areas, in particular in building canyons. No single approach will be able to reliably provide the accuracy required by the target use cases in all environmental conditions. As demonstrated so far, while today's GNSS-based solutions are able to provide high accuracy positions, they have limitations for urban canyons and indoor applications. On the other hand, 5G-based positioning solutions can complement and provide accurate position estimates for both indoor and outdoor scenarios. Therefore, hybrid solutions that optimally combine 5G approaches with GNSS/INS based sensors are most promising approaches. Another additional important benefit is an increased fault tolerance and improved integrity of the overall solution, delivering a quantitative measure of confidence to go along with each position estimate.

In step a), GNSS satellite signals are received from at least one GNSS satellite and GNSS localization data are determined using the received GNSS satellite signals. Typically, at least partially in parallel or simultaneously, GNSS satellite signals are received from a plurality of GNSS satellites. For example, respective GNSS localization data can be determined from the GNSS satellite signals by time-of-flight measurements and/or further evaluations. For example, the GNSS localization data determined in this way can include at least so-called GNSS pseudo-range data or GNSS pseudo-path data, which describe the spatial length of the signal propagation path between the respective GNSS satellite and the vehicle. However, due to impairments, such as atmospheric signal delays and/or multi-path propagation through reflections on objects in the vicinity of the vehicle, these GNSS pseudo-range data can describe signal propagation paths that are longer than the actual (shortest) distance between vehicle and satellite (at the time of sending out the respective GNSS satellite signal). This can result in erroneous GNSS measurements.

In step b), 5G signals are received and 5G localization data are determined using the received 5G signals. For example, 5G signals can be received from a plurality of 5G stations (each comprising at least one 5G transmitting device and one 5G receiving device) in the vicinity of the vehicle. The 5G signals can in particular also comprise information about the (geodetic) absolute position of the respective 5G station. Through time-of-flight of the 5G signals, the relative positions or distances between the vehicle and the respective 5G station can be determined. The determined relative positions or distances of the vehicle to a plurality of the 5G stations can in particular be combined with the information concerning the (geodetic) absolute position of the respective 5G station to, for example, a 5G-based vehicle position, for example in the manner of a triangulation.

The 5G cellular network advantageously contributes to the fact that the high requirements present in localization applications of in particular automated or autonomous vehicles can be particularly advantageously met in terms of the reliability, availability, coverage, and/or latency of the transmission types used. This helps to ensure that particularly high accuracy (as far as possible in the centimeter range) and/or particularly high integrity values can be achieved in the localization.

The new frequency allocation of 5G is particularly advantageous for cellular-based localization, because larger bandwidths at higher frequencies are available (mm wave above 24 GHz in addition to below 6 GHz). Larger bandwidths help to more accurately resolve signal time (there is an inverse relationship between time and bandwidth), so that larger bandwidths provide an improved ability to resolve multi-path effects, the main source of failures in unclear urban areas and/or interior spaces, because signals traversing different paths arrive at different times.

Switching to the new frequencies in 5G also has a particular advantageous effect on the geographic distribution of cellular base stations and antenna technologies used, which in turn favors cellular-based localization. Moreover, the introduction of 5G antenna arrays with beam-forming functions can advantageously help to direct signals in the direction of end users. A higher density of direction-detecting or direction-sensitive antennas can advantageously improve the resolution of multi-path components by measuring the delay, the arrival, and/or the exit angle and can thus in particular improve the localization performance. Additionally, 5G can advantageously allow vehicles to be located with a single 5G station.

In step c), a first integrity datum is determined in consideration of at least received 5G signals and/or determined 5G localization data. For example, the first integrity datum can be a 5G integrity datum, such as a 5G integrity or protection level. In order to determine the first integrity datum, GNSS localization data can be compared to 5G localization data. Based on this comparison and/or any possible differences in GNSS localization data and 5G localization data, the 5G integrity and/or protection level can be determined. For example, in order to determine the first integrity datum via the 5G network, prior GNSS observations can be received for reference, in particular for estimating a protection level as reliable as possible.

In the method, 5G signals can (thus) advantageously be used as an external source for calculating the protection level for a GNSS/INS system. In particular, based on at least one 5G position datum, at least one or more virtual (artificially generated) GNSS pseudo-ranges (so-called 5G position GNSS pseudo-ranges) can be determined. These can be compared to one or more (really measured) GNSS pseudo-path measurements. From this, one or more 5G GNSS residues (5G position NSS pseudo-range(s) minus GNSS pseudo-range measurement(s)) can be calculated. In particular, the GNSS virtual pseudo-ranges can be generated for the epoch from which the really measured GNSS pseudo-ranges originate to which they are to be compared. Based on the 5G-GNSS residues, advantageously the first integrity datum, in particular a protection level, can be determined. In order to determine the integrity datum, a statistical limit of the 5G residues can be determined in an advantageous manner.

According to an advantageous embodiment, it is proposed that the integrity datum be a protection level.

The integrity is typically an important criterion for evaluating the performance of modern GNSS/INS localization sensors. Further important criteria are usually the accuracy, continuity, and availability. Integrity can in particular be defined as the measure of trust that can be placed in the accuracy of the information provided by a GNSS (GNSS/INS) system. This concept can be advantageously used in order to measure the impact of navigational performance on safety.

The protection level (PL) is a by now common parameter of the integrity concept for GNSS and/or INS-based localization systems. The protection level generally describes a statistical error limit that is calculated so that the probability that the absolute error (e.g., position error, route error, or speed error) that in particular exceeds an alarm limit is less than or equal to the desired integrity risk. The protection level is typically obtained by the use of GNSS/INS measurements, and an external system is not typically used in order to ensure the protection level.

The method described provides a particularly advantageous approach to using 5G-based position information in order to use, in particular, previous GNSS observations as a reference for estimating a protection level that is as reliable as possible, in particular in critical situations, such as in urban areas.

According to a further advantageous embodiment, it is proposed that the differences between GNSS localization data and 5G localization data, respectively, are used in order to determine the first integrity datum. In order to determine corresponding, potentially existing differences, GNSS localization data can be compared to 5G localization data.

According to a further advantageous embodiment, it is proposed that a second integrity datum be determined in consideration of at least received GNSS satellite signals or determined GNSS localization data. For example, the second integrity datum can be a GNSS or GNSS/INS integrity datum, such as a GNSS (GNSS/INS) integrity or protection level. The second integrity datum can in particular be a variance-based integrity datum. This can be determined, for example, from the output covariance matrix of a GNSS system, in particular a filter, such as a Kalman filter of the GNSS system.

According to a further advantageous embodiment, it is proposed that an overall integrity datum be determined using the first integrity datum and the second integrity datum.

According to a further advantageous embodiment, it is suggested that, when determining the overall integrity datum, a weighting of first integrity datum to second integrity datum is performed as a function of at least one weighting indicator. This can advantageously help to provide a weighted protection level. For example, at least one environmental indicator can be used in order to advantageously define the weighting between the integrity data. For example, the geometry of the satellites (HDOP) can be used as an indicator of the weighting between the integrity data. Alternatively or cumulatively, for example, a carrier-to-noise ratio (C/NO), in particular as a representative of signal strength, can be used as an indicator of the weighting between the integrity data.

In a further aspect, a computer program for carrying out a method presented herein is proposed. In other words, this relates in particular to a computer program (product) comprising instructions that, when the program is executed by a computer, cause the computer to execute a method described herein.

According to a further aspect, a machine-readable storage medium is proposed on which the computer program proposed herein is deposited or stored. Regularly, the machine-readable storage medium is a computer-readable disk.

According to a further aspect, a localization device for a vehicle is proposed, wherein the localization device is configured so as to carry out a method described herein. The localization device can, for example, comprise a computer and/or a controller that can execute instructions to execute the method. For this purpose, the computer or the controller can, for example, execute the specified computer program. For example, the computer or the controller can access the specified storage medium in order to execute the computer program. For example, the localization device can be a movement-and-position sensor, in particular arranged in or on the vehicle.

In a further aspect, a use of 5G signals for determining a protection level for a GNSS system is proposed.

The details, features and advantageous embodiments discussed in connection with the method can also occur in the computer program and/or the storage medium and/or in the localization device and/or the use presented herein, and vice versa. In this respect, reference is made in full to the statements there regarding the more detailed characterization of the features.

### BRIEF DESCRIPTION OF THE DRAWINGS

The solution presented herein and its technical environment are explained in further detail below with reference to the figures. It should be noted that the disclosure is not to be limited by the exemplary embodiments shown. In particular, unless explicitly shown otherwise, it is also possible to extract partial aspects of the facts explained in the figures and to combine them with other components and/or findings from other figures and/or the present description. The following is shown schematically:

FIG. 1: an exemplary workflow of the method presented herein, and

FIG. 2: an exemplary application possibility of the method presented herein.

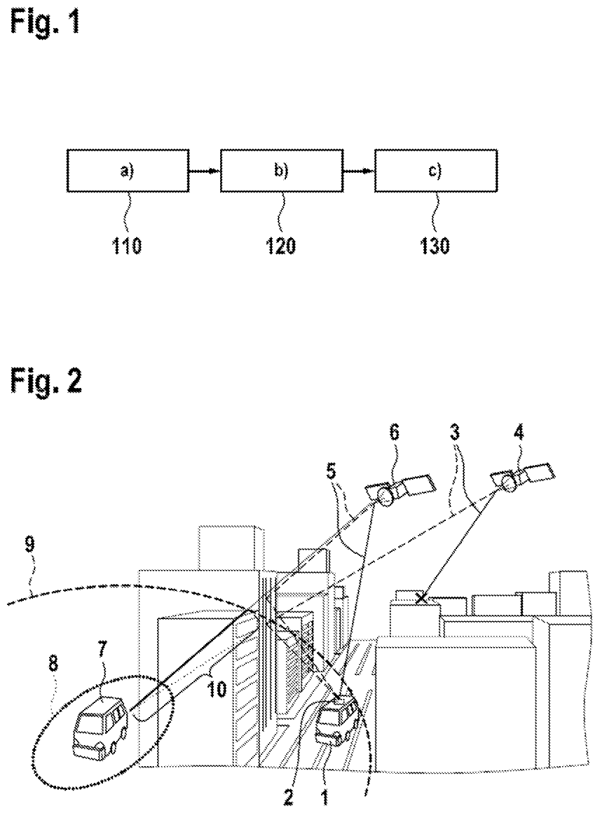

FIG. 1 schematically shows an exemplary workflow of the method presented herein. The method is used in order to determine an integrity datum regarding a GNSS-based localization of a vehicle 1 (cf. FIG. 2).

### DETAILED DESCRIPTION

In block 110, according to step a), GNSS satellite signals 3 are received from at least one GNSS satellite 4, and GNSS localization data is determined using the received GNSS satellite signals 3. In block 120, according to step b), 5G signals 5 are received and 5G localization data are determined using the received 5G signals 5. In block 130, according to step c), a first integrity datum is determined in consideration of at least received 5G signals 5 or determined 5G localization data.

Preferably, the integrity datum is a protection level. The protection level (PL) is a by now common parameter of the integrity concept for GNSS and/or INS-based localization systems. The protection level generally describes a statistical error limit that is calculated so that the probability that the absolute error (e.g., position error, route error, or speed error) that in particular exceeds an alarm limit is less than or equal to the desired integrity risk.

FIG. 2 shows an exemplary application possibility of the method presented herein. This is illustrated herein, for example, by way of a vehicle 1 having a localization device 2 configured so as to carry out the method and moving in an urban environment, such as a canyon, in particular. The 5G station 6 is illustrated herein, for example, in the form of a further satellite. However, the 5G station can generally also be arranged fixedly, for example on the earth's surface, such as on a building.

In a particularly advantageous design variant of the method, one or more 5G-based positions can be used in order to generate virtual GNSS observations based on previous knowledge from the 5G-based positions, which can be used as a reference for estimating an integrity datum, in particular a protection level that is as reliable as possible.

Because 5G is less sensitive to multi-path effects, it can advantageously be possible to provide as robust a detection of GNSS measurements with multi-path effects as possible. This approach can be particularly advantageously used in urban canyons, because the GNSS signals are typically more at risk of being compromised there. On the other hand, the advantage can be that typically a 5G-based position can advantageously be determined more reliably in urban environments due to the availability of dense networks.

For example, in the method, a pseudo-range measurement provided by the GNSS receiver can be described according to the following formula:

P_{r,i}^{s}=ρᵣ^{s}+δρ^{s}+c·(δt^{s}−δtᵣ)+I_{r,i}^{s}+Tᵣ^{s}+d_{r,i,P}−d_{i,P}^{s}+m_{r,i,P}^{s}+ε_{r,i,P}^{s}

Here, P_{r,i}^{s} is the pseudo-distance measurement between the receiver r and the satellite s on the frequency i at the reception time (m). ρᵣ^{s} is the geometric distance between the position of the satellite s at the transmitting time and the position of the receiver r at the reception time (m). δρ^{s} is the orbital error of the satellite s at the transmitting time (m). δt^{s} is the clock error of the satellite at the transmitting time (m). δtᵣ is the timing error of the receiver r at the reception time (m). I_{r,i}^{s} is the ionospheric signal delay observed between the receiver r and satellite s on the frequency i at the timepoint (m). Tᵣ^{s} is the tropospheric signal delay observed between the receiver r and satellite s at the timepoint (m). d_{r,i,P} is the code hardware delay observed on the receiver r at the frequency i at the timepoint (m). d_{i,P}^{s} is the code hardware delay observed on the satellite s at the frequency i at the timepoint (m). m_{r,i,P}^{s} ε_{r,i,P}^{s} is the pseudo-distance measurement error at the timepoint (m) due to multi-path propagation. the pseudo-distance measurement error at the timepoint (m) due to receiver noise.

In the method, with the aid of at least one 5G position, one or more 5G position-based pseudo-distances or pseudo-ranges can be generated, for example according to the following formula:

P_{r,i}^{s}=ρᵣ^{s}+δρ^{s}+c·(δt^{s}−δtᵣ)

From the difference between the two pseudo-ranges, one can advantageously determine pseudo-range residues, hereinafter referred to as 5G residues. The protection level can then be determined, for example, by the statistics of the 5G residues, for example, by determining the percentile of 99%. The obtained protection level, hereinafter referred to as 5G-GNSS-based PL, is a GNSS-based protection level. This offers an example of the fact that, and if applicable how, the differences between GNSS localization data and 5G localization data can be used in order to determine the first integrity datum.

The obtained 5G-GNSS-based protection level, which is a GNSS-based protection level, can be advantageously compared to a variance-based protection level, hereinafter referred to as a GNSS-INS-based protection level, which can be generated, for example, from the starting covariance matrix of the GNSS/INS system. This offers an example of the fact that, and if applicable how, a second integrity datum can be determined in consideration of at least received GNSS satellite signals 3 or determined GNSS localization data.

In particular, when there are large differences between the two types of protection levels, which can depend on, for example, indicators such as number of satellites, HDOP, and/or C/NO, each protection level can be weighted differently and the weighted average protection level can be output as the final protection level of the system. This offers an example of the fact that, and if applicable how, an overall integrity datum can be determined using the first integrity datum and the second integrity datum. In addition, this offers an example of the fact that, and if applicable how, when determining the overall integrity datum, a weighting of first integrity datum to second integrity datum can be carried out as a function of at least one weighting indicator.

In order to illustrate a corresponding difference between the two types of protection levels, FIG. 2 indicates by way of example a difference 10 between a 5G-GNSS-based protection level 9 and a GNSS-(INS)-based protection level 8. Both refer to a (GNSS or GNSS/INS-) estimated position 7, which is discernibly false due to the shown multi-path propagation of the GNSS signal 3. In this context, it can be seen that the true position of the vehicle 1 is not within the GNSS-(INS)-based protection level 8, but rather within the 5G-GNSS-based protection level 9.

This also offers an example of an advantageous use of 5G signals 5 in order to determine a protection level for a GNSS system.

What is claimed is:

1. A method for determining an integrity datum regarding a GNSS-based localization of a vehicle, comprising:
receiving GNSS satellite signals from at least one GNSS satellite and determining GNSS localization data using the received GNSS satellite signals;
receiving 5G signals and determining 5G localization data using the received 5G signals; and
determining a first integrity datum in consideration of at least received 5G signals or determined 5G localization data.

2. The method according to claim 1, wherein the integrity datum is a protection level.

3. The method according to claim 1, wherein the differences between GNSS localization data and 5G localization data are used in order to determine the first integrity datum.

4. The method according to claim 1, wherein a second integrity datum is determined in consideration of at least received GNSS satellite signals or determined GNSS localization data.

5. The method according to claim 4, wherein an overall integrity datum is determined using the first integrity datum and the second integrity datum.

6. The method according to claim 5, wherein, when determining the overall integrity datum, a weighting of first integrity datum to second integrity datum is performed as a function of at least one weighting indicator.

7. A computer program for carrying out a method according to claim 1.

8. A machine-readable storage medium on which the computer program according to claim 7 is stored.

9. A localization device for a vehicle configured so as to carry out a method according to claim 1.

10. A use of 5G signals in order to determine a protection level for a GNSS system.
